(19) United States
(12) Patent Application Publication
(10) Pub. No.: US 2005/0103506 A1
(43) Pub. Date: May 19, 2005

(54) Fire protection method

(76) Inventors: Malcolm John Warrack, Kloof (ZA); Willem Jacobus Oosthuizen, Pietermaritzburg (ZA)

Correspondence Address: Angenehm Law Firm. Ltd., P.O. Box 48755, Coon Rapids, MN, 55448-0755, US

(21) Appl. No.: 10/717,187

(22) Filed: Nov. 18, 2003

(51) Int. Cl. A62C 2/00; A62C 3/00; B67D 5/08

(52) U.S. Cl. 169/43; 169/44; 169/45

(57) ABSTRACT

A method to protect assets within a defined region against the threat of fire, including the steps of: A) positioning aerial forest fire fighting assets within a range allowing the assets to reach and attack a surveyed fire anywhere within a periphery of one or more strategic assets within 60 minutes of issuance of an order to attack a fire; B) integrating available regional ground fire fighting assets to follow up initial forest fire aerial attacks; C) continually surveying of the periphery of the strategic assets using one or more sensors, the periphery being at least ten miles in radius; D) gathering surveillance data from sensors in a central command; E) analyzing surveillance data according to user defined algorithms and database data in the central command; F) generating an alarm status in the central command based on data analysis of surveillance data combined with reference data; G) alerting the aerial forest fighting assets when data analysis justifies such alerting, such alerting being communicated by the central command; H) initiating an order to aerial attack a detected fire using the aerial forest fighting assets, when data analysis justifies such order, such order being issued by the central command; I) alerting hierarchical superior fire fighting command and control assets when data analysis justifies such alerting, such alerting being communicated by the central command; and J) repeating steps C through I when the comparison justifies repeating the steps.

This invention lies in the field of detection systems, for example a detection system for the detection of forest fires.

This specification will described detection of forest fires as an example.

Forest fires, often caused by natural phenomena, or by human negligence, result in great economic loss, the loss of human and animal lives, and a detrimental cost to the eco-structure. Often, fire fighters reach the scene of the fire when the damage has already been done, due to the fact that they are not always promptly notified of such fires. The result is that vast hectares of land are burnt, which often require costly clearing up operations and replanting. The current method of detecting forest fires results in foresting companies having to spend extra time and money employing more sophisticated fire fighting equipment to extinguish the rapidly spreading fire, with consequent increased risk to fire fighting personnel.

Many detection systems have been brought to the fore, for example smoke detection sensors coupled to alarm systems. However, the inevitability of false alarms casts a doubt upon the accuracy and undermines the practical utility of such systems. The other disadvantage with these systems is that they are largely dependent upon constant operator surveillance and a rapid response by him in order to achieve the main aim of fire detection.

Recent developments have lead to fire detection systems which employ thermal cameras, coupled to a processing and controlling system, which continuously monitors the forest and alerts personnel of the presence of a forest fire. However, the major disadvantage with this type of system is the substantial cost of the thermal cameras which results in high costs for initially setting up the system. A cost of more than R 70,000-00 is not unusual for a thermal camera as at the date of writing this specification.

Therefore, a need exists for an improved fire detection system which reduces the extent of operator intervention while at the same time detects fires accurately with a reduced number of or preferably no false alarms. By the same token, a need exists for a detection system that provides an early detection of fire at a cost that is of benefit to the forestry industry.

Furthermore, there is also a need for more sophisticated motion detection systems.

It is therefore an object of the present invention to provide an intelligent detection system capable of intelligently detecting the presence of a fire, or the detection of any other form of motion relating to fire, through the use of modern computing power employing controlling and detection algorithms so as to overcome the disadvantages associated with detection systems of the prior art.

A further object of this invention is the provision of means for the detection of movement, specifically smoke and flame by day and glow by night together with other characteristic parameters or identifiers of the fire, for our example of a fire detection system, which employs a computer controlled programme conducting the operation of comparing the electronic images received by means, such as cameras, to a preprogrammed information residing in the memory means of the computer with the result that an alarm is triggered and the operator alerted upon the detection of fire, as in our example, or any other related movement required to be detected.

In accordance with an aspect of the present invention, there is provided a method of automatically detecting motion which involves the steps of:
storing preselected patterns in terms of characteristic identifiers of the type of motion required to be detected in memory means of a computer;
capturing images in the form of image frames of the area in which the detection of motion is required;
storing the image frames in memory by means of the computer;
extracting characteristic identifiers of the motion required to be detected, from the image frames;
storing the characteristic identifiers in memory means of the computer;
updating the preselected pattern with the characteristic identifiers;
storing a sensitivity value in memory by means of the computer;
comparing the extracted characteristic identifiers with the preselected patterns;
comparing the characteristic identifiers with the sensitivity value if the characteristic identifiers correspond with the preselected patterns;
activating alerting means if the sensitivity value is exceeded.

In accordance with a preferred feature of the present invention, the motion required to be detected is fire, in particular, the fire is detected by detecting one or a combination selected from the following characteristic identifiers related to fires:
smoke or flame is detected during day time conditions,
change in light intensity is detected during night time conditions,
the source of the light intensity
the source of smoke or flame of the fire,
the direction of motion of the center of gravity of the fire,
the persistent nature of the fire,
the terrain information pertaining to the area required to be detected, and
the infra red radiation of the fire.

This information forms part of the said preselected patterns. The image frames captured are stored in the memory means of the computer, and together with the preselected patterns, are used to detect the fire.

Images from the plurality of cameras are captured or digitised frame by frame. This process is also commonly known as “frame grabbing”. A graphics programme then enhances the quality of the image. The characteristic identifiers are extracted from the image frame, and the preselected patterns is updated or further developed preferably via a neural network, as explained below, wherafter the extracted preselected patterns is compared to the stored preselected patterns for the detection of a fire. The detection is carried out by an intelligent imaging process which involves the subtraction of the present captured image from the past stored image, thereby detecting any changes or motion in the monitored area. Naturally, image frames with similar information need to be compared, in other words, like image frames must be compared. In order to achieve this, under the influence of the computer programme, a shift in the stored image frames is carried out until the relevant image frame is found, and this past image frame is then compared to the presently captured image frame for the detection of the required motion. The retrieval of the specific required image may be carried out by using known electronic stabilisation techniques.

Once it has been established that the required motion has been identified, the motion is indicated on suitable display means by means of a graphic display. This display may vary according to a preselected alarm level. Unwanted moving objects, for example, moving vehicles, or trees swaying in the wind will not hinder the imaging process due to the comparison of the preselected patterns, and in particular the characteristic identifiers which define the specified motion. The sensitivity of the sector may be preselected by the controller.

It has been mentioned above that the preselected patterns is updated preferably via a neural network. A neural network is akin to the human brain, in that it contains a plurality of branch nodes inter linked by branch paths through which information is passed and the end result is that the network allows a computer to “learn” i.e. by building a pattern or a series of patterns which could also be referred to as a database, such that in future, the computer independently bases its decision making process upon the information it has learnt in the past.

Once the fire is detected, it is once again compared to a sensitivity or a reference “value”, which may either be in a form of a look up table or a preselected patterns with predetermined information, and if this value is exceeded the computer alerts an operator, for example, by means of an alarm, or a voice interface module which audibly provides specific information, such as the location, status, direction of the fire. A preferable feature which can be incorporated within the computer, by way of a computer programme, is the ability of the programme to indicate the most optimum access routes in order to avoid the fire or to fight the fire.

In accordance with a second aspect of the present invention, there is provided an automatic intelligent motion detection system comprising at least one observation post accommodating a video camera, the video camera capturing images which are transmitted by suitable telecommunication means to a control station, the control station accommodating at least one computer which captures the images originating from the video camera in real time, the computer digitising the image frames and storing this information in its memory means, the memory means further storing a preselected patterns related to characteristic identifiers of the type of motion required to be detected, and this preselected patterns being compared to characteristic identifiers extracted from the image frame for the detection of the particular type of motion, under the influence of a computer program also residing in the computer's memory means, the display and detection of motion being displayed on a suitable monitor connected to the computer.

In accordance with a preferred feature of the present invention, a plurality of observation posts are suitably positioned around the control station. This arrangement allows for a wider area to be monitored.

Preferably, the video camera is housed in a protective encasement, thereby enhancing its durability and extending its life span.

The cameras are accommodated on the observation post such that they may be either manually or automatically rotated. The cameras may be continuously rotated through an angle, for example, of 335° back to back in the horizontal plane covering, for example, a 360° field of view, or alternatively, the camera may be rotated at predetermined time periods only. The camera may also be panned, tilted and zoomed. The above controlling of the camera may be conducted manually from the control room via a device adapted for such purpose, with the control signals being transmitted via the telecommunication, means. Alternatively, the controlling of the camera may be carried out automatically using the said telecommunication means and under the influence of the computer programme.

The said telecommunication means could comprise either one or a combination, selected from a radio channel (i.e. microwave channel), a satellite channel, fibre optic cable or electrical conductor.

In accordance with a further preferred feature of the present invention, the camera is solar powered or wind powered, or both. Accordingly, during day light, solar rays source the camera, while wind generators source the camera during low light intensity and night time conditions. Preferably, the camera is also battery backed, thus ensuring continuous operation in the event of the solar power means or wind power means malfunctioning.

The control centre is preferably provided with an uniterruptable power supply (UPS) to ensure reliable operation even in the event of a power failure.

In use, the video camera captures the images in a form of a series of image frames, the capturing occurring under the influence of the computer programme. Preferably, the captured image frames may be enhanced to facilitate motion detection, the enhancing function being carried out under the influence of the computer programme. Typically, the enhancing functions may include a noise reduction feature, the enhancement of the picture contrast, and other such similar enhancing features.

The images are captured and displayed on display means coupled to the computer. The past stored image frame is subtracted from the present captured image frame, thereby identifying the motion and displaying this by way of the graphics. By using the preselected patterns, the computer programme is able to detect whether the required motion has been identified. By comparing the extracted preselected patterns with the sensitivity “value”, alerting means is activated if the this “value” is exceeded.

The computer monitor is preferably provided with touch screen control functions so as to facilitate the easy operation of the system and further to reduce the possibility of incorrect keys pressed in the case where a keyboard is used, for example. This feature also allows a relatively unskilled operator to operate the detection system.

The camera specified may have an infra red facility for use at night.

The invention will be more fully described by way of example with reference to the accompanying drawings in which:

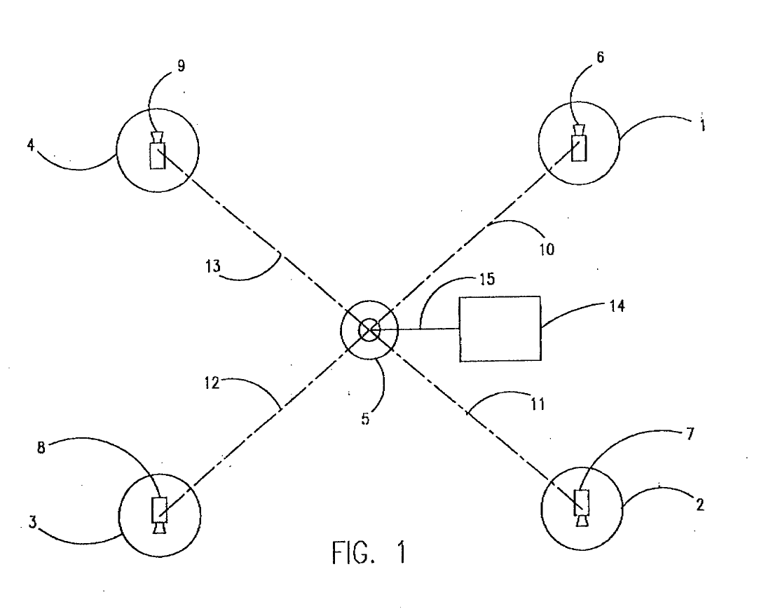

FIG. 1 is a schematic representation of the manner in which the detection system is configured, and

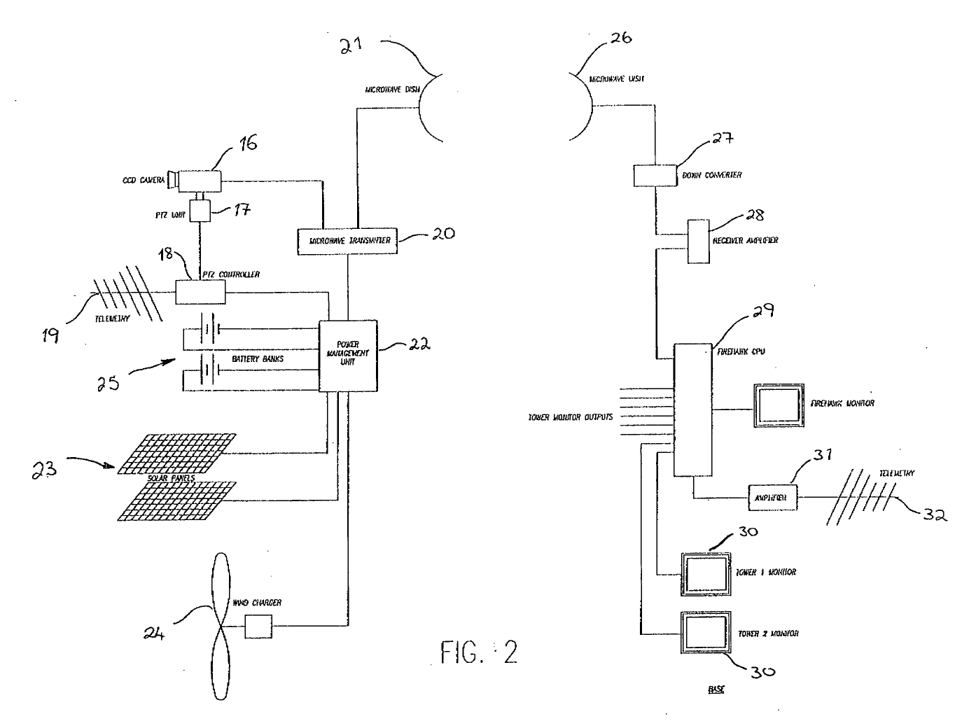

FIG. 2 is a schematic representation of individual components of the motion detection system and the configuration thereof.

The detection system of the present invention comprises at least one, but preferably a plurality of observation posts or towers for a wider field coverage. FIG. 1 shows four towers 1 to 4 strategically positioned around a central tower 5 which, for convenience, will be referred to as a receiving tower, however, it is used for both receiving and transmitting information.

The towers are equipped with cameras 6 to 9, and each camera is encased in a protective housing. The camera is provided with means, such as a motor with suitable mountings accommodating the camera body, which means allow it to be rotated continuously or manually, from the control centre, through, for example an angle of 335° in the horizontal plane covering a 360° field of view. The means may also allow the camera to be rotated stepwise or through a predetermined range, for example. The means also allows the camera to be tilted in the vertical plane. This may be carried out by gearing, for example.

Signals from the cameras are transmitted to receiver tower 5 through telecommunication channels 10 to 13. The channel could comprise a microwave link, for example. The signals are then transmitted to control centre 14 via conductor 15, which could be a fibre optic cable. A conductor is preferred for this link since the distance between the receiver tower and the control centre would be small, thereby making such a link feasible, and further, a fibre optic cable reduces the possibility of noise interference as is the case in telecommunication channels.

FIG. 2 shows in greater detail the components of the system at the observation post and the control station. At the Lower, the camera is coupled to a PTZ unit 17 which allows for the panning, tilting and zooming of the camera. This unit is controlled by a PTZ controller 18 which receives control signals from the computer 29 at the control station via a telemetry channel comprising antenna 19. Images captured by the camera are transmitted to the microwave transmitter 20 which relays this information to the control station via microwave dish antenna 21. The aforementioned units are powered via the power management unit 22 which sources and manages the power from solar panels 23 and wind generator 24. Accordingly, energy is provided by solar radiation through the solar panels during conditions of adequate solar radiation intensity. While the wind generator sources the units during low solar radiation intensity, for example during night time conditions or overcast conditions. In the event of failure of the solar or wind generator units, the units are powered by backup batteries 25.

At the control centre, the captured images are received in microwave signal form by microwave dish antenna 26. The signals are demodulated and filtered by converter unit 27. The converter unit may also carry out other functions such as enhancing the signal to noise ratio, for example. The signals are amplified by receiver amplifier 28. The signals are then fed into the computer 29. Under the influence of the computer programme residing in memory means of the computer, fire detection and alerting is carried out as described above.

Monitors 30 associated with each camera on each observation post are coupled to the computer and accordingly display the images captured by the respective cameras. A telemetry channel is also coupled to the computer, which telemetry channel comprises an amplifier 31 to amplify control signals, and an antenna 32. Through this channel, control signals are transmitted to the PTZ controller 18 on the observation post, for controlling the panning, tilting and zooming functions of the camera.

1. A method of automatically detecting motion which involves the steps of:
storing preselected patterns in terms of characteristic identifiers of the type of motion required to be detected in memory means of a computer;
capturing images in the form of image frames of the area in which the detection of motion is required;
storing the image frames in memory by means of the computer;
extracting characteristic identifiers of the motion required to be detected, from the image frames;
storing the characteristic identifiers in memory means of the computer;
updating the preselected patterns with the characteristic identifiers;
storing a sensitivity value in memory by means of the computer;
comparing the extracted characteristic identifiers with the preselected patterns;
comparing the characteristic identifiers with the sensitivity value if the characteristic identifiers correspond with the preselected patterns;
activating alerting means if the sensitivity value is exceeded.

2. A method of automatically detecting motion as claimed in claim 1, in which the motion refers to a fire.

3. A method of automatically detecting motion as claimed in claim 2, in which the fire is detected by detecting smoke and flame during day time conditions.

4. A method of automatically detecting motion as claimed in claim 2, in which the fire is detected by detecting change in light intensity during night time conditions.

5. A method of automatically detecting motion as claimed in claim 2, in which the fire is detected by detecting the source of light intensity or smoke and flame of the fire.

6. A method of automatically detecting motion as claimed in claim 2, in which the fire is detected by detecting the direction of motion of its center of gravity.

7. A method of automatically detecting motion as claimed in claim 2, in which the persistent nature of the fire is used in the detection thereof.

8. A method of automatically detecting motion as claimed in claims 2, in which terrain information pertaining to the area required to be detected is used in the detection of fire.

9. A method of automatically detecting motion as claimed in claim 2, in which the fire is detected by detecting the infra red radiation thereof.

10. A method of automatically detecting motion as claimed in any one of claims 2 to 9, in which the smoke, flame, and change in light intensity, source of the fire, direction of fire, the persistent nature of the fire, the terrain, and infra red radiation information forms part of the preselected patterns which is used for fire detection purposes.

11. A method of automatically detecting motion as claimed in any one of claims 1 to 10, which involves the step of enhancing the captured image prior to storage in memory means of a computer.

12. A method of automatically detecting motion as claimed in claims 11, in which the captured image is enhanced under the influence of a computer program residing in memory means of a computer.

13. A method of automatically detecting motion as claimed in claims 1 to 12, in which information not related to the particular type of motion required to be detected is rejected under the influence of a computer programme residing in memory means of a computer, which computer programme uses the preselected patterns for such purpose.

14. A method of automatically detecting motion as claimed in claims 1 to 13, in which a captured frame is compared to a like previously stored frame for motion detection.

15. A method of automatically detecting motion as claimed in claim 14, in which the previously stored frame is found by electronic shifting of the image frames under the influence of the computer programme.

16. A method of automatically detecting motion as claimed in claims 14 and 15, in which the required motion is identified by subtracting a past captured image from the present captured image, and identification taking place by using a preselected patterns of the required motion.

17. A method of automatically detecting motion as claimed in claims 15 and 16, in which the required motion is indicated by a technique which involves the flickering of two consecutive image frames leading to the flashing of parts of the image which has undergone motion.

18. A method of automatically detecting motion as claimed in any one of claims 1 to 17, in which the preselected patterns is updated by way of a neural network.

19. A method of automatically detecting motion as claimed in claims 1 to 18, in which the preselected patterns is updated after the capture of every image frame.

20. A method of automatically detecting motion as herein generally described.

21. An automatic intelligent motion detection system comprising at least one observation post accommodating a video camera, the video camera capturing images which are transmitted by suitable telecommunication means to a control station, the control station accommodating at least one computer which captures the images originating from the video camera, the computer digitising the image frames and storing this information in its memory means, the memory means further storing a preselected patterns related to characteristic identifiers of the type of motion required to be detected, and this preselected patterns being compared to characteristic identifiers extracted from the image frame for the detection of the particular type of motion, under the influence of a computer program also residing in the computer's memory means, the display and detection of motion being displayed on a suitable monitor connected to the computer.

22. An automatic intelligent motion detection system as claimed in claim 21 which comprises a plurality of observation posts suitably positioned around a control station.

23. An automatic intelligent motion detection system as claimed in any one of claims 21 or 22, in which the video camera is suitably housed in a protective encasement.

24. An automatic intelligent motion detection system as claimed in any one of claims 21 to 23, in which the telecommunication means is a radio channel.

25. An automatic intelligent motion detection system as claimed in any one of claims 21 to 23, in which the telecommunication means is a satellite channel.

26. An automatic intelligent motion detection system as claimed in any one of claims 21 to 23, in which the telecommunication means is a fibre optics cable.

27. An automatic intelligent motion detection system as claimed in any one of claims 21 to 23, in which the telecommunication means is an electrical conductor.

28. An automatic intelligent motion detection system as claimed in any one of claims 21 to 27, in which the video camera is mounted on means allowing it to be rotated.

29. An automatic intelligent motion detection system as claimed in claim 28, in which the video camera is rotated automatically under the influence of the computer programme residing in the computer's memory means, the rotation of the camera being facilitated by transmitting appropriate signals via the said telecommunication means.

30. An automatic intelligent motion detection system as claimed in any one of claims 21 to 28, in which the video camera is rotated manually using a device adapted for this purpose, the device being accommodated in the control station, and control signals for rotating the video camera being transmitted by the said telecommunication means.

31. An automatic intelligent motion detection system as claimed in any one of claims 28 to 30, in which the video camera is rotated continuously.

32 An automatic intelligent motion detection system as claimed in any one of claims 28 to 30, in which the video camera is rotated at predetermined time periods only.

33. An automatic intelligent motion detection system as claimed in claim 30, in which the said manual device is adapted to manually pan, tilt and zoom the video camera.

34. An automatic intelligent motion detection system as claimed in any one of claims 21 to 33, in which the video camera is solar powered.

35. An automatic intelligent motion detection system as claimed in any one of claims 21 to 33, in which the video camera is powered by a wind generator.

36. An automatic intelligent motion detection system as claimed in any one of claims 21 to 33, in which the video camera is powered by both solar panels and wind generators.

37. An automatic intelligent motion detection system as claimed in any one of claims 34 to 36, in which a backup battery is provided for the video camera in order to reduce the risk of the video camera discontinuing operation in the event of solar power means malfunctioning.

38. An automatic intelligent motion detection system as claimed in any one of claims 21 to 37, in which the control station is provided with an uninterruptable power supply (UPS).

39. An automatic intelligent motion detection system as claimed in any one of claims 21 to 38, in which the capture of images from the video camera is carried out in the form image frames, this form of capturing taking place under the influence of a computer program.

40. An automatic intelligent motion detection system as claimed in any one of claims 21 to 39, in which a suitable display means is coupled to the computer to display the captured images.

41. An automatic intelligent motion detection system as claimed in any one of claims 21 to 40, in which the identification of the required motion is carried out by comparing the extracted characteristic identifiers with the preselected patterns and a sensitivity value stored in the memory means of the computer.

42. An automatic intelligent motion detection system as claimed in any one of claims 21 to 41, in which the updating of the preselected patterns is carried out by a neural network residing in the computer, such updated preselected patterns being further used in the identification of the required motion.

43. An automatic intelligent motion detection system as claimed in as claimed in any one of claims 21 to 42, in which suitable alerting means is activated by the computer to alert personnel of the presence of required alarm event.

44. An automatic intelligent motion detection system as claimed in claim 43, in which the alerting means is an audible alarm.

45. An automatic intelligent motion detection system as claimed in claim 43, in which the alerting means is a speech synthesiser.

46. An automatic intelligent motion detection system as claimed in any one of claims 21 to 45, in which the computer, via the computer program, is adapted to discard motion not forming part of the motion required to be detected.

47. An automatic intelligent motion detection system as claimed in any one of claims 21 to 46, in which the motion required to be detected is fire.

48. An automatic intelligent motion detection system as claimed in claim 47, in which the computer under the influence of the computer program is adapted to indicate the most optimum access route towards, or to avoid the fire.

49 An automatic intelligent motion detection system as claimed in claim 47, in which an infra red sensor relays information pertaining to the infra red radiation of the fire, which information forms part of the preselected patterns, and is used in the detection of fire.

50. An automatic intelligent motion detection system as claimed in any one of claims 21 to 49, in which the computer program allows the enhancement of the captured image frames.

51. An automatic intelligent motion detection system as claimed in any one of claims 21 to 50, in which interaction with the system is carried out using touch screen technology, with the display means of claim 33 being the interaction medium.

52. An automatic intelligent motion detection system as claimed in any one of claims 21 to 51, in which interaction with the system is carried out using a keyboard.

53. An automatic intelligent motion detection system as herein generally described.

54. An automatic intelligent motion detection system as herein specifically described with reference to the accompanying drawings.
